(19) United States
(12) Patent Application Publication
(10) Pub. No.: US 2008/0259362 A1
(43) Pub. Date: Oct. 23, 2008

(54) User-generated color tonal reproduction curves (CTRCS) for highlight color (HLC) and monochrome printers

(75) Inventor: Richard T. Horn, Claremont, CA (US)

Correspondence Address: OLIFF & BERRIDGE, PLC., P.O. BOX 320850, ALEXANDRIA, VA, 22320-4850, US

(73) Assignee: XEROX CORPORATION, Stamford, CT (US)

(21) Appl. No.: 11/785,531

(22) Filed: Apr. 18, 2007

(51) Int. Cl. H04N 1/60

(52) U.S. Cl. 358/1.9

(57) ABSTRACT

A system and methods for providing user-generated color tonal reproduction curves (CTRCs) to enhance color information when the prints will be made on a monochrome or highlight color printer. A graphical user interface (GUI) is provided to allow the user to generate tonal reproduction curves (TRCs) for each of the four separations of the color images thereby choosing what color features for the given document need emphasis on the monochrome printers. The same TRC may be applied to the color objects in a page description language (PDL) file.

### BACKGROUND

This disclosure generally relates to digital image manipulation and user interfaces for xerographic devices and specifically relates to color tonal reproduction curves (CTRCs).

Print fulfillment companies receive files to print from many different customers with different applications creating pages that have images that may have color content of personal agents, such as in real estate offerings, scenery such as in brochures, and equipment repair publications, such as in recall notices. The same documents tend to also have color highlighted graphs, text, and/or advertisements. In many cases, the customers want their files printed on a variety of printers form color to monochrome. Because these embedded images come from many different sources, the quality varies as to lightness, darkness, color and tonal range. Light or darkness can be adjusted if necessary to some extent on the printer, but there is no way for the user to choose what color features need emphasis on the monochrome printers. Instead, a locked average conversion provided with a printer is used when a print fulfillment company is printing color text and images bearing inputs from many sources that are out of the control of the person printing them.

Often a printer customer, such as a service bureau or graphic communications company, receives print-ready files that contain color images, text and graphics with inadequate darkness range and contrast and a dependence on light but normally visible colors on a printout from a color printer to emphasize key points of information. If the source files are unavailable for adjustment and the file is printed without correction, the results are often dull and disappointing with detail lost and some of the color highlights totally lost or blended into the background.

Standard controller settings for the highlight color and monochrome printers provide customers with the ability to change both the printed lines per inch (halftone screen) and the darkness level. In the majority of cases, this produces acceptable print quality; however, for a significant number of customers both large and small, additional tools are required to ensure that fine detail is not lost in low contrast transitions or in the conversions of different colors with like intensities.

### SUMMARY

One aspect is a method for enhancing color information. An interface is provided for creating and maintaining at least one user-generated color tonal reproduction curve (CTRC). The user-generated CTRC are stored and applied to a page description language (PDL) file, which is sent to a non-color printer. The user-generated CTRC may be assigned to a print queue for the non-color printer. The user-generated CTRC may be modified in the interface based on receiving at least one control point input. The control point input may include the following functions: move, add, and x-y coordinates. An interface may be provided for creating and maintaining a CTRC group, the CTRC group including the user-generated CTRC. The non-color printer may be one of a monochrome or highlight color printer. The CTRC may include CYMK curves or RGB curves. Creating and maintaining the CTRC may include editing, copying, deleting, printing, saving, importing, exporting, selecting, and clearing.

Yet another aspect is a computer-readable medium storing instructions for performing this method for enhancing color information.

Another aspect is a system for enhancing color information, including a graphical user interface (GUI), a memory, a processor and a communications component. The GUI is for creating and maintaining at least one user-generated color tonal reproduction curve (CTRC). The memory is for storing the user-generated CTRC. The processor is for applying the user-generated CTRC to a page description language (PDL) file. The communications component is for sending the PDL file to a non-color printer. The processor is connected to the memory and communications component and the memory stores instructions for the interface. The processor may assign the user-generated CTRC to a print queue for the non-color printer. The processor may modify the user-generated CTRC in the interface based on receiving at least one control point input. The GUI may create and maintain a CTRC group, where the CTRC group includes the user-generated CTRC. The non-color printer may be a monochrome or a highlight color printer. The CTRC may include CYMK or RGB curves.

### BRIEF DESCRIPTION OF THE DRAWINGS

The file for this patent contains at least one drawing executed in color. Copies of this patent with color drawings will be provided by the U.S. Patent and Trademark Office upon request and payment of the necessary fee.

FIG. 1 is a block diagram of an exemplary operating environment;

FIG. 2 is a screenshot of an exemplary embodiment of a printer manager, which is part of a graphical user interface (GUI);

FIG. 3 shows a screenshot of an exemplary embodiment of a user TRC window of the printer manager of FIG. 2;

FIG. 4 is a screenshot of an exemplary embodiment of a new TRC edit window of the printer manager of FIG. 1;

FIG. 5 shows an exemplary embodiment of a method of creating a new user TRC using FIGS. 2-4;

FIG. 6 shows an exemplary embodiment of the new TRC edit window of FIG. 4, after TRC data is added for a new TRC;

FIGS. 7 and 8 show screenshots of an exemplary embodiment of an image quality window of the printer manager of FIG. 2;

FIG. 9 is an original color swatch;

FIG. 10 is a grayscale interpretation for a conventional printer; and

FIG. 11 is a grayscale interpretation for a printer incorporating embodiments of the present invention.

### DETAILED DESCRIPTION OF EMBODIMENTS

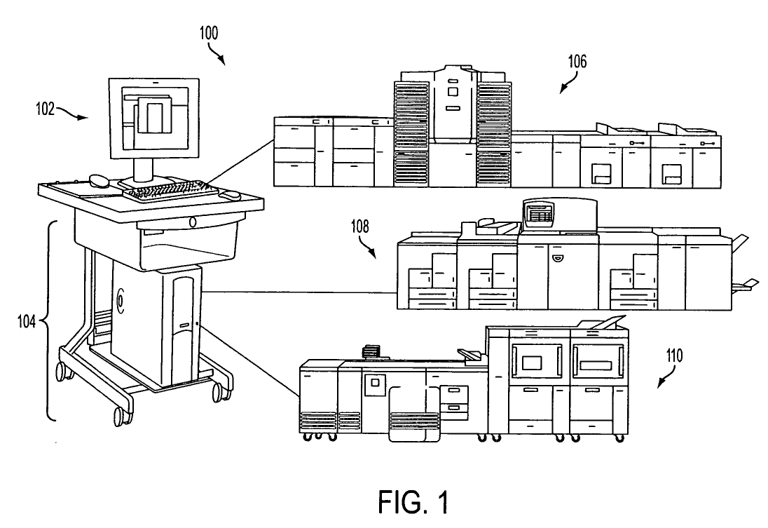

FIG. 1 is a block diagram of an exemplary operating environment 100. Operating environment 100 includes a graphical user interface (GUI) 102 associated with a controller 104, which is in communication with different kinds of xerographic devices 106, 108, 110, such as printers, facsimile devices, scanners, copiers, and multi-functional machines. The controller is any kind of processor, such as a Macintosh (Mac) or Personal Computer (PC). The xerographic devices 106, 108, 110 may produce monochrome, highlight color, or full color images.

Exemplary embodiments of the present invention allow a grayscale or color image to be printed on a monochrome or highlight color device with enhanced grayscale conversion. The grayscale conversion is enhanced through user-generated color tonal reproduction curves (CTRCs, which is used interchangeably with TRCs herein), which may be edited on the GUI 102. The CTRCs are applied by, for example, the controller 104 to information in a page description (PDL) file. The PDL may be any kind of PDL, such as a page composition language (PCL) file or a PostScript file generated from an Adobe® program or other graphic arts programs. The adjusted file may be sent from the controller 104 to a monochrome or highlight color printer for printing. Alternatively, the adjustments to the file based on the CTRCs may be done locally at the monochrome or highlight color printer by hardware or software.

Exemplary embodiments include systems and methods for using user-generated CTRCs to enhance color information for printing to a monochrome or highlight color printer. Exemplary embodiments may be embodied in hardware, software, or firmware or any combination thereof. For example, exemplary embodiments may be incorporated into the hardware of the controller 104 or distributed among the controller 104 and the xerographic devices 106, 108, 110. Alternatively, exemplary embodiments may be software stored in a memory of the controller 104 and/or the xerographic devices 106, 108, 110. At least a portion of the exemplary embodiments may be implemented as one or more hardware circuits within an application-specific integrated circuit (ASIC), using a programmable logic device (PLD), such as a field programmable gate array (FPGA), a programmable logic array (PLA) or a programmable array logic (PAL), using discrete logic elements or discrete circuit elements or the like. At least a portion of the exemplary embodiments may be implemented as software instructions stored in memory, such as read-only memory (ROM), programmable read-only memory (PROM), erasable programmable read-only memory (EPROM), electrically erasable programmable read-only memory (EEPROM), compact disc read-only memory (CD-ROM), digital video disc read-only memory (DVD-ROM) or the like.

One exemplary embodiment is a GUI 102 is that allows a user to generate CTRCs for each of the separations of the color images (e.g., CYMK) thereby choosing what color features for the given document need emphasis on the monochrome printers. The same CTRC may be applied to all color objects in the PDL file. The user can choose to use these curves at a print queue level to adjust every PostScript file submitted. The adjustments are applied to every object in the file that relies on a PDL decomposer, (e.g., a PostScript decomposer) to produce a halftone pattern to simulate a shade of gray. The adjustments re-map what the PDL decomposer would normally produce to a more appropriate range of tonal variations to emphasize image characteristics, color and value. In one embodiment, the CTRCs can be selected at the print queue level for application to all PostScript print files that are submitted to that queue.

Color tonal reproduction curve (CTRC) control for printers allows users to improve the printed appearance of images (native grayscale or color) by increasing the contrast of adjacent shaded and color areas that would have been interpreted by the printer controller software into halftones with almost identical density. “Wash out” detail is then visible, objects in shadow are distinguishable and some gradients appear smoother. If the density between the printer-generated adjacent halftones is too far apart, TRC can be used to reduce the tonal range and smooth out abrupt gradient changes or make stark contrasts between objects in a picture appear more natural.

The color tonal reproduction curves graphically relate the input color values of the source file and the desired output (printed) grayscale values for monochrome or highlight color printers. By adjusting this curve, (e.g., mapping selected input values to new output values), the file will be printed with tonal ranges, which have been broadened or compressed as appropriate. The CTRCs are applied at print time.

In one embodiment, a CTRC group can be created, named, saved and otherwise edited in a display on the controller 102, (e.g., pop-up window) by dragging control points on the curves, by editing control points in a table, or other graphical editing methods. CTRCs can also be printed for archival purposes.

In one embodiment, multiple CTRCs can be saved and different ones assigned on a queue-by-queue basis. The CTRC selection for a given queue can be changed between jobs. Because the CTRC operates at the queue level, the entire print file is affected by any changes to the curve, including all images as well as shaded or colored fonts and lines.

One exemplary embodiment is a system that includes a CTRC control feature. The CTRC control feature includes two interdependent elements: (1) a PostScript decomposer loaded and enabled on the printer controller; and (2) a CTRC control feature enabled on the printer controller.

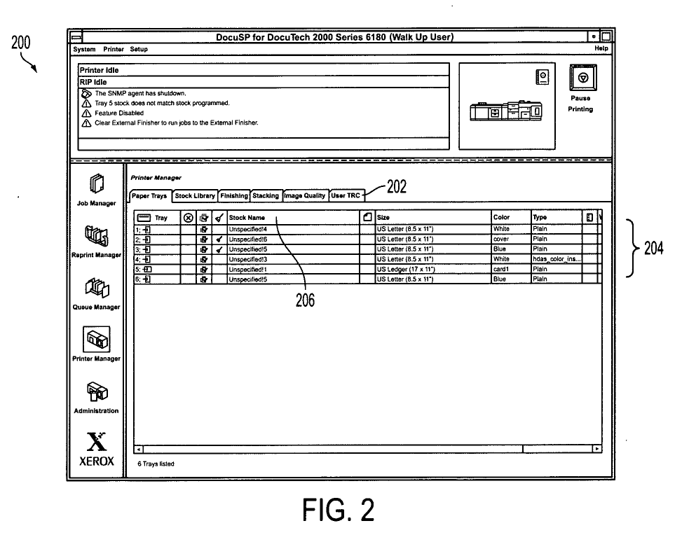

FIG. 2 shows screenshot of an exemplary embodiment of a printer manager 200, which is a part of the GUI 102. The printer manager 200 includes a User TRC tab 202. User TRC tab 202 enables the user to view all CTRCs, create new CTRCs, and view, edit, copy delete existing CTRCs, among other functions. Printer manager 200 includes a table 204 listing CTRCs, which can be sorted by either name 206 or the file modified date (not shown) by clicking on the column headings, in one embodiment.

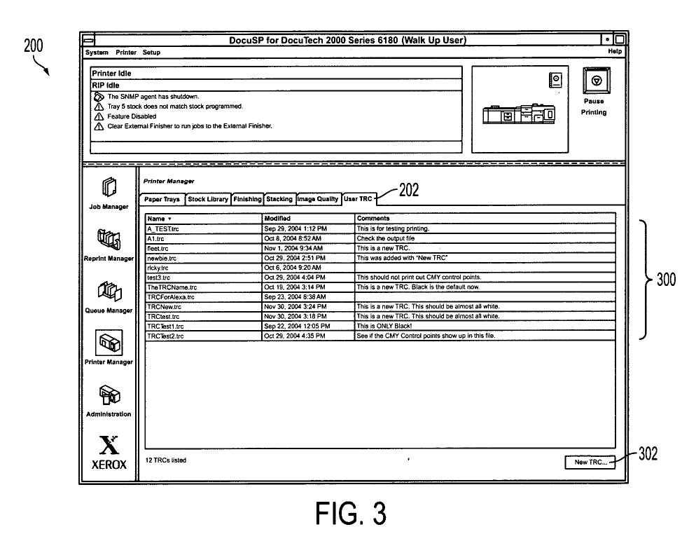

FIG. 3 shows a screenshot of an exemplary embodiment of the printer manager 200 of FIG. 2, after the User TRC tab 202 is selected. Selection of the User TRC tab 202 within the printer manager 200 results in a display 300 of available public CTRCs and TRCs, as shown in FIG. 3. In this example, the following selections appear when you right-click on one of the available public CTRCs, by accessing a pull-down menu or other graphical selection methods: edit, copy, delete, print, new, TRC, import, export, select all, and clear all. Other editing functions may also be used to implement this exemplary embodiment.

With the edit selection, the user may edit the selected TRC. With the copy selection, the user may copy the selected TRC to another location. With the delete selection, the user may delete the selected TRC. With the new selection, the user may create a new “User TRC” or, alternatively, the user may select the “New TRC” button 110 in the “User TRC” tab 102. With the import selection, the user may import a user TRC from another controller. With the export selection, the user may export a user TRC to another printer controller that has this feature enabled. With the select all selection, the user may select all the options. With the clear all selection, the user may deselect all the options.

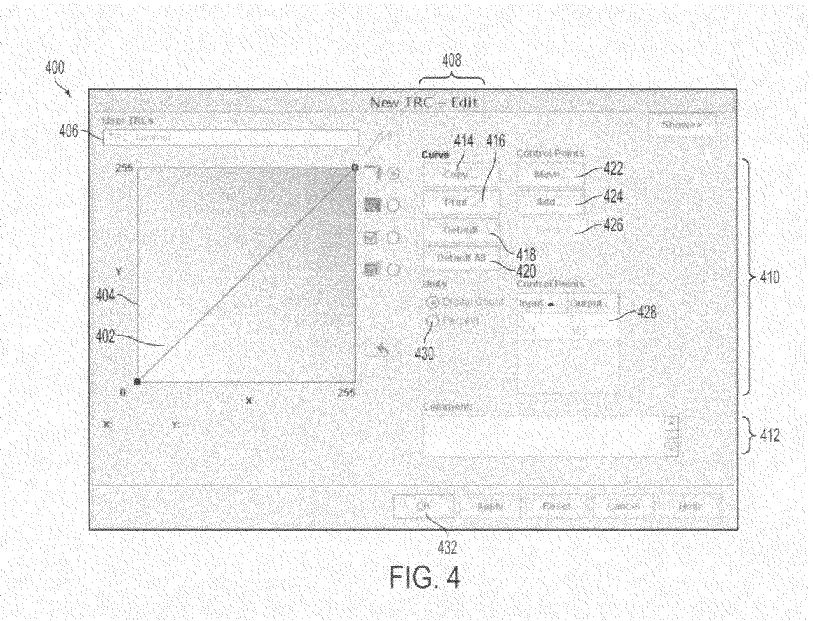

FIG. 4 shows a screenshot of an exemplary new TRC edit window 400 of the printer manager 200 of FIG. 2. The user may navigate to the new TRC edit window 400 by selection of the “New TRC” button 302 of FIG. 3. “Identity” curves 402 are displayed in a graph 404 for the default User TRC named “TRC_Normal” 406 in this example. The identity curves 402 (also called contrast curves) describe a state in which no gray level changes will be made to the printed output normally expected from the monochrome printer. The new TRC edit window 400 includes curve options 408, control point options 410, and a comment 412. The curve options 408 include copy 414, print 416, default 418, and default all 420. The control point options 410 include move 422, add 424, delete 426, input and output 428 and units 430. Comment 412 allows the user to optionally enter a description of each curve. Control points define a point on each curve while it is being edited. There may be one or more control points on a given curve. While this example has specific options and functions, there are many other equivalent ways to implement the basic idea of creating and maintaining CTRCs through GUIs and otherwise.

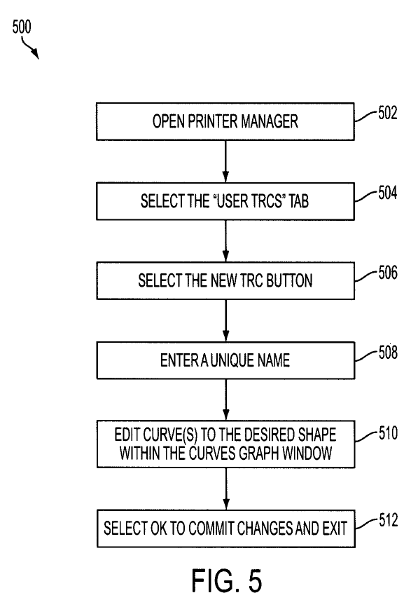

FIG. 5 shows an exemplary embodiment of a method 500 of creating a new user TRC using FIGS. 2-4. To create a new “User TRC”, the user opens the printer manager 200 at 502 and selects the User TRCs tab 202 (as shown in FIG. 2) at 504. The user selects the new TRC button 302 (as shown in FIG. 3) at 506 to open the new TRC edit window 400 (as shown in FIG. 4). On the new TRC edit window 400, the user enters a unique name (e.g., “TRC_Normal” 406 shown in FIG. 4) at 508, edits one or more curves 402 to the desired shape within the graph 404 at 510 and selects the “OK” button 432 to commit changes and exit the new TRC window 400 at 512.

FIG. 6 shows an exemplary embodiment of the new TRC edit window 400 of FIG. 4, after TRC data is added for a new TRC named “TRC_new”. In this example, the graph 404 includes four curves representing the four colors cyan 600, yellow 602, black 604 and magenta 606 (CYMK). The TRC being edited comprises these four curves. In other embodiments, different curves are shown in graph 404, such as red, green and blue curves (RGB) and more or less curves may be shown.

After a curve is selected to be adjusted (i.e., it is an active curve), the user may position the mouse on the active curve and click and drag the curve into the desired shape. Alternatively, the user may set a control point or multiple control points that will change the active curve into a more complex shape or use other graphical editing techniques. Setting control points is the recommended practice if the user knows exactly what digital output is desired, given a specific input. Setting control points is intended for specific changes. After the user enters (x,y) coordinates in the input and output 428 option, the user selects the add control point option 424 to commit changes. A box (not shown) may be displayed in the graph 404 on the curve, which may be clicked and dragged to another point to reshape the curve. Multiple control points per curve may be set. Other editing techniques may also be used.

For example, a user may edit a curve so that yellow input has a deeper contrast to start with and a deeper contrast to end, but just the opposite in the middle of the curve. This changes the contrast levels for printing yellow. In one embodiment, a window is displayed showing the color shifting so that the user can see what the colors would look like in monochrome. The window shows black and white squares and how they would shift.

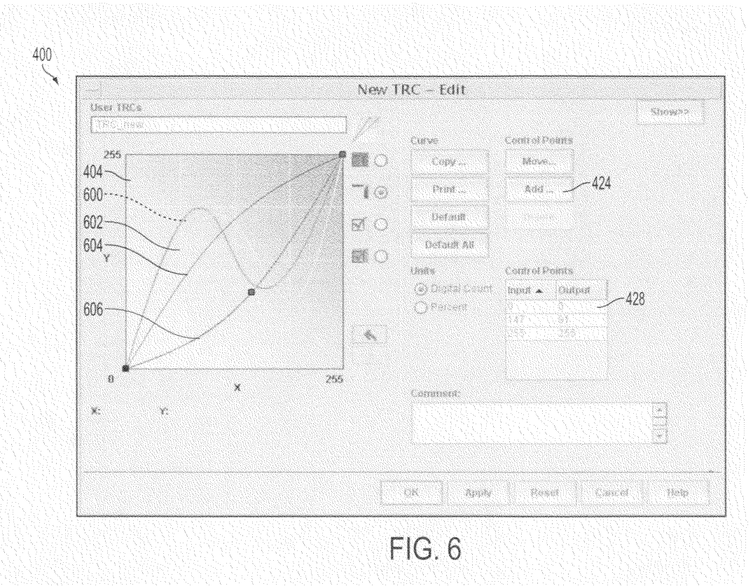

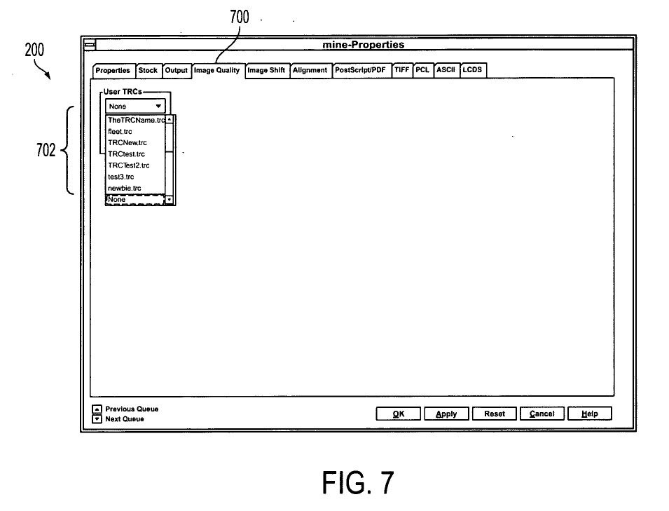

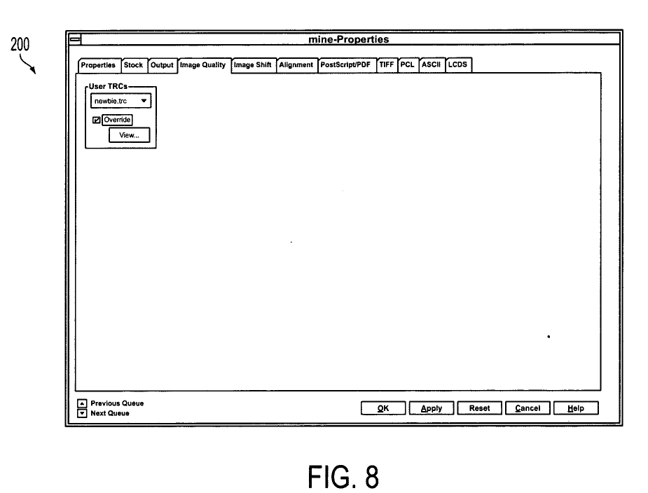

FIGS. 7 and 8 show screenshots of an exemplary embodiment of a printer quality window of the printer manager 200 of FIG. 2, after the “Image Quality” tab 700 selected. Once a TRC is added, the TRC is stored in storage device (e.g., a database associated with controller 102 of FIG. 1) and is made available for selection by each associated printer queue. In this example, FIG. 7 shows a drop down menu 702 listing some available TRCs that were added. The user may select a TRC for each queue. The selected TRC can be chosen to override the default for that queue, as shown in FIG. 8.

For example, a user may desire to emphasize red as being more prominent in a black and white picture when it is printed. The user selects the TRC that works best and associate it with a lead queue. The user wants the lead queue to emphasize. Suppose, the user wants all the print jobs sent to the lead queue to emphasize red and all the jobs sent to the print queue will emphasize green. The user picks which TRC to associate with the lead and print queues to get the desired effect.

Another exemplary embodiment is a method of converting user-generated TRCs to information in a file, such as a PostScript file. Within the PostScript file, arrays can be inserted that will change the TRC for each color of the resultant print output. These arrays provide a method for controlling the grayscale representation. The arrays do this by changing the grayscale value that can be from 0 (black or no color) to 1 (white or full color) on a pixel-by-pixel basis. A PostScript function called setcolortransfer constructs arrays from the user-generated TRC as shown in Table 1. The basic functionality may of course be implemented in various ways and in other kinds of PDL.

TABLE 1
/transarrayC[
0 0 0 0 1 1 1 1 1 1 1 2 2 2 2 2
2 3 3 3 3 3 3 4 4 4 4 4 5 5 5 5
5 6 6 6 6 6 7 7 7 7 7 8 8 8 8 9
9 9 9 10 10 10 10 11 11 11 11 12 12 12 12 13
13 13 13 14 14 14 15 15 15 15 16 16 16 17 17 17
17 18 18 18 19 19 19 20 20 20 21 21 21 22 22 22
23 23 23 24 24 24 25 25 25 26 26 26 27 27 27 28
28 29 29 29 30 30 30 31 31 32 32 32 33 33 33 34
34 35 35 36 36 36 37 37 38 38 38 39 39 40 40 41
41 41 42 42 43 43 44 44 45 45 45 46 46 47 47 48
48 49 49 50 50 51 51 52 52 53 53 54 54 54 55 55
56 56 57 58 58 59 59 60 60 61 61 62 62 63 63 64
64 65 65 66 66 67 68 68 69 69 70 70 71 71 72 73
73 74 74 75 75 76 77 77 78 78 79 80 80 81 81 82
83 83 84 84 85 86 86 87 87 88 89 89 90 91 91 92
92 93 94 94 95 96 96 97 98 98 99 100 100 100 100 100
] def
/transarrayM[
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
] def
/transarrayY[
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
] def
/transarrayK[
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
100 100 100 100 100 100 100 100 100 100 100 100 100 100 100 100
] def
{ 255 mul cvi transarrayC exch get 100 div
}
{ 255 mul cvi transarrayM exch get 100 div
}
{ 255 mul cvi transarrayY exch get 100 div
}
{ 255 mul cvi transarrayK exch get 100 div
} setcolortransfer

The setcolortransfer function operates in PostScript to map the grays and colors requested to a set of grays that the PostScript interpreter uses for imaging. The array in Table 1 has 256 values, one for each of the 256 gray values. For example, if gray level 0.5 is requested, the setcolortransfer function multiplies 0.5 by 255 and converts the gray level to an integer, yielding 127 in this case. The setcolortransfer function looks up the 127^{th} value in the array (i.e., 33) and divides it by 100, resulting in 0.33 setgray (i.e., a 67-percent tint). This conversion makes that area be interpreted by the printer as darker. In this exemplary embodiment, the array is constructed from the user-generated TRC and inserted into the PostScript file before printing. In this example, an 8-bit description of a pixel allows for 255 different numbers. Other implementations may use other pixel descriptions or percentages (e.g., 0-100% in place of 0-255).

The sample arrays in Table 1 are created from the user-generated TRCs and the arrays are inserted into the PostScript file to enhance printing. The print job is captured before processing and the arrays are inserted in particular locations to adjust the TRCs according to the user-generated TRCs and, then, the file is rewritten and submitted to the monochrome or highlight printer. The printer reads and interprets the file and adjusts how it prints the page with the fine tuning and adjustments preferred by the user.

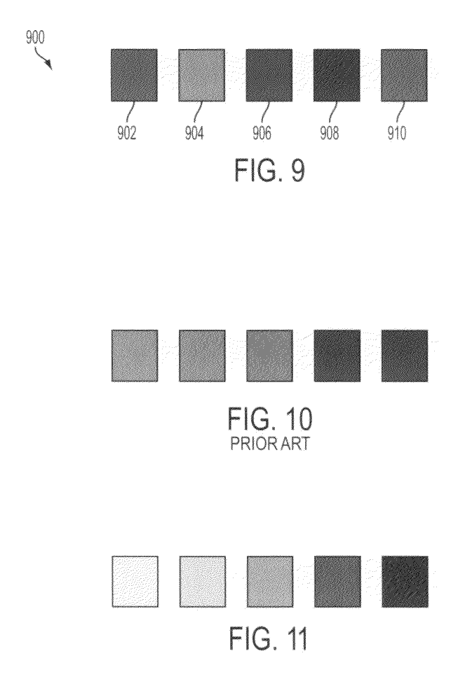

FIGS. 9-11 show an original color swatch (FIG. 9) and the difference between grayscale interpretation for a conventional printer (FIG. 10) and for a printer incorporating embodiments of the present invention (FIG. 11). FIG. 9 shows the original color swatch 900, which has a wide range of colors (i.e., orange 902, yellow-green 904, blue-green 906, blue 908, and purple 910) that might be used in highlighting a chart or text. FIG. 10 shows that printing with a conventional printer having normal grayscale conversion loses much of the effect of the contrasting colors. FIG. 11 shows how printing with pre-application of a user-generated CTRC using exemplary embodiments of the present invention can emphasize contrast differences by changing the grayscale interpretation, among other benefits.

Exemplary embodiments have many advantages, including providing a consistent look in a number of images, adjusting images to make certain colors look better in monochrome or highlight printing, increasing emphasis or contrast in images, adjusting contrast ranges by, for example, raising darkness ranges and the like. For example, a customer who gathers images from a variety of sources may modify CTRCs on different print queues to make the images have a consistent look and feel, increasing the customer's control. Exemplary embodiments allow multiple curves for multiple print queues to be modified so that the color information may work for monochrome, highlight, and color printing. In this manner, customers may have more control over the quality and customization of the printing, e.g. tuning a printer for different source input. Adjustments to the PDL file from applying the TRC may produce a more appropriate range of tonal variations to emphasize image characteristics, color, and value.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A method for enhancing color information, comprising:
providing an interface for creating and maintaining at least one user-generated color tonal reproduction curve (CTRC);
storing the user-generated CTRC,
applying the user-generated CTRC to a page description language (PDL) file; and
sending the PDL file to a non-color printer.

2. The method of claim 1, further comprising:
assigning the user-generated CTRC to a print queue for the non-color printer.

3. The method of claim 1, further comprising:
modifying the user-generated CTRC in the interface based on receiving at least one control point input.

4. The method of claim 3, wherein control point input includes one or more of the following functions: move, add, and x-y coordinates.

5. The method of claim 1, further comprising:
providing an interface for creating and maintaining a CTRC group, the CTRC group including the user-generated CTRC.

6. The method of claim 1, wherein the non-color printer is one of a monochrome or highlight color printer.

7. The method of claim 1, wherein the CTRC includes one of CYMK curves or RGB curves.

8. The method of claim 1, wherein creating and maintaining the CTRC includes one or more of the following functions: editing, copying, deleting, printing, saving, importing, exporting, selecting, and clearing.

9. A system for enhancing color information, comprising:
an graphical user interface (GUI) for creating and maintaining at least one user-generated color tonal reproduction curve (CTRC);
a memory for storing the user-generated CTRC;
a processor for applying the user-generated CTRC to a page description language (PDL) file; and
a communications component for sending the PDL file to a non-color printer;
wherein the processor is connected to the memory and communications component; and
further wherein the memory stores instructions for the interface.

10. The system of claim 9, wherein the processor assigns the user-generated CTRC to a print queue for the non-color printer.

11. The system of claim 9, wherein the processor modifies the user-generated CTRC in the interface based on receiving at least one control point input.

12. The system of claim 9, wherein the GUI creates and maintains a CTRC group, the CTRC group including the user-generated CTRC.

13. The system of claim 9, wherein the non-color printer is one of a monochrome or highlight color printer.

14. The system of claim 9, wherein the CTRC includes one of CYMK curves or RGB curves.

15. A computer-readable medium storing instructions for performing a method for enhancing color information, the method comprising:
providing an interface for creating and maintaining at least one user-generated color tonal reproduction curve (CTRC);
storing the user-generated CTRC;
applying the user-generated CTRC to a page description language (PDL) file; and
sending the PDL file to a non-color printer.

16. The computer-readable medium of claim 15, further comprising:
assigning the user-generated CTRC to a print queue for the non-color printer.

17. The computer-readable medium of claim 15, further comprising:
modifying the user-generated CTRC in the interface based on receiving at least one control point input.

18. The computer-readable medium of claim 15, further comprising:
providing an interface for creating and maintaining a CTRC group, the CTRC group including the user-generated CTRC.

19. The computer-readable medium of claim 15, wherein the non-color printer is one of a monochrome or highlight color printer.

20. The computer-readable medium of claim 15, wherein the CTRC includes one of CYMK curves or RGB curves.
